(19) United States
(12) Patent Application Publication
(10) Pub. No.: US 2021/0050768 A1
(43) Pub. Date: Feb. 18, 2021

(54) Saddle Coil for a Rotor of an Electrical Machine

(71) Applicant: SIEMENS AKTIENGESELLSCHAFT, München (DE)

(72) Inventors: Tabea ARNDTt, Erlangen (DE); Jörn GRUNDMANN, Großenseebach (DE); Peter van HASSELT, Erlangen (DE); Michael FRANK, Uttenreuth (DE); Marijn Pieter OOMEN, Erlangen (DE)

(73) Assignee: Siemens Aktiengesellschaft, München (DE)

(21) Appl. No.: 16/977,443

(22) PCT Filed: Feb. 26, 2019
(86) PCT No.: PCT/EP2019/054739

§ 371 Date: Sep. 1, 2020

(30) Foreign Application Priority Data
Mar. 2, 2018 (DE) 10 2018 203 139.8

(51) Int. Cl. H02K 55/04; H01F 6/06; H02K 3/18; H02K 3/52

(52) U.S. Cl. CPC H02K 55/04; H02K 3/527; H02K 3/18; H01F 6/06

(57) ABSTRACT

A saddle coil for a rotor comprising: two poles of an electrical machine having a plurality of coil turns; for each coil turn of the plurality of coil turns, two straight longitudinal sections having a first length and, following on at a right angle from the longitudinal sections, two transverse sections symmetrically curved and with a second length less than the first length. Each longitudinal section and each transverse section includes a coil conductor with a high-temperature superconductor tape. The coil conductors are connected to one another at the corners of the saddle coil by pressing and/or soldering.

### CROSS-REFERENCE TO RELATED APPLICATIONS

This application is a U.S. National Stage Application of International Application No. PCT/EP2019/054739 filed Feb. 26, 2019, which designates the United States of America, and claims priority to DE Application No. 10 2018 203 139.8 filed Mar. 2, 2018, the contents of which are hereby incorporated by reference in their entirety.

### TECHNICAL FIELD

The present disclosure relates to electrical machines. Various embodiments include saddle coils for a rotor, comprising at least two poles and/or electrical machines.

### BACKGROUND

Synchronous electrical machines, for example for use in power plant generators, the rotor coils of which comprise conductor segments in tape form, in particular high-temperature superconductor tapes, have already been proposed. The use of high-temperature superconductors (HTS) can increase the efficiency of the synchronous machine and improve various other properties. High-temperature superconductor tapes, in particular ones comprising flat, thin high-temperature superconductor layers on metallic substrates in tape form, exhibit promising properties for the production of coil windings. A general advantage when using high-temperature superconductor tapes is that a current can flow almost without loss at a temperature below the critical temperature of the superconductor.

In the production of coil windings from such high-temperature superconductors, however, it is necessary to take into account the fact that high-temperature superconductor tapes are generally very sensitive to mechanical loads. In this case, it proves relatively simple to wind two-dimensional planar coil geometries, i.e. flat coils/racetrack coils (“pancake coils”), although it is found significantly more difficult to produce other, three-dimensional coil geometries, even though this would be desirable. This is because for a two-pole rotor of an electrical synchronous machine, such as is used in most power plant power generators, the axially extending longitudinal sections of the rotor coil are ideally placed close to the symmetry plane (equatorial plane) of the rotor. In the case of flat coils, the coil ends must be brought past very close to the machine axis. This entails many technical difficulties.

The rotor iron thus can no longer be forged as a single steel object, but must be assembled from a plurality of parts, for example riveted shaft ends, so that the flat coils can be fastened on the rotor. This leads to the creation of mechanical weaknesses and may lead to dynamic instabilities, particularly in large machines with high centrifugal forces and tensile loads. It is furthermore necessary to take into account the fact that rotor coils comprising high-temperature superconductors need to be cooled down to low operating temperatures. In known cooling concepts, cooling fluid is fed into the rotor and out from the rotor close to the rotor axis. The same applies to the lines for coil current and coil voltage. In the case of flat coils, this leads to problems in design and production.

In order to solve these problems, it has been proposed to arrange flat coils slightly offset with respect to the equatorial plane in order to keep the rotor axis available for the cooling access and the current lines. For example, WO 01/20756 A1 discloses a superconducting machine comprising a multi-pole winding arrangement, in which two partial coils that are symmetrical with respect to a midplane (of the aforementioned equatorial plane) and consist of a stack of planar racetrack-type coil elements are used. Each coil element is made from high-T_{c} superconductors in tape form. DE 203 18 174 U1 discloses a double-pancake winding consisting of two flat single-pancake windings insulated from one another, which are wound from a conductor in tape form comprising high-T_{c} superconductor material. In this case, a relatively easily producible internal contacting possibility is intended to be provided for use in electrical machines.

In some systems, a high-temperature superconductor tape is wound to form a three-dimensional saddle coil, so that the coil ends can extend at a distance from the rotor axis. An article by M. P. Oomen et al., “Transposed-Cable Coil & Saddle Coils of HTS for Rotating Machines: Test Results at 30 K”, IEEE Trans. Appl. Superconductivity 19-3, pages 1633 to 1638 (2009), describes the formation of a three-dimensionally shaped coil winding by subsequent bending of a flatly wound oval winding into the shape of a cylinder surface.

DE 10 2008 035 655 A1 discloses a possibility of already winding the high-temperature superconductor tape three-dimensionally. In order to avoid pronounced bending of the tape conductor, however, in both cases space-occupying winding heads are required in order to connect the longitudinal sections of the coil winding in their axial end regions and at the same to allow small bending radii of the tape conductor. These winding heads lead to a high space requirement. A rotor produced with such windings is therefore relatively long, which in turn leads to a high weight and to high material consumption.

Methods for electrically connecting high-temperature superconductor tapes, in particular comprising second-generation high-temperature superconductors, with a very low resistance are already known in the prior art, for example by pressing together with indium (cf. in this regard the article by S. Ito et al., “Structure and Magnetic Field Dependences of Joint Resistance in a Mechanical Joint of REBCO Tapes”, IEEE Transactions on Applied Superconductivity, 26-4, page 6601505 (2016)) or by careful soldering (cf. in this regard for example the article by S. L. Lalitha, “Low resistance splices for HTS devices and applications”, Cryogenics (2017), DOI: http://dx.doi.org/10.1016/j.cryogenics.2017.06.003, and the article by T. Lécrevisse et al., “Tape-to-Tape Joint Resistances of a Magnet Assembled with (RE)BCO Double-Pancake Coils”, IEEE Transactions on Applied Superconductivity, 25-3, page 6602505 (2015)). These methods are used in order to obtain tape sections which are longer than those that can be obtained commercially (i.e. tape sections with a length of several 100 m) and in order to assemble compact magnet systems from a plurality of racetrack coils.

### SUMMARY

The teachings of the present disclosure include saddle coils made from a high-temperature superconductor tape, is three-dimensionally shaped, with a relatively low space requirement on the head sides and as far as possible avoids excessively high mechanical loads of the high-temperature superconductor tape. For example, some embodiments include a saddle coil (2) for a rotor (1), comprising at least two poles, of an electrical machine, characterized in that the rectangular saddle coil (2) comprises, for each coil turn (6), two straight longitudinal sections (7) having a first length and, following on at a right angle from the longitudinal sections (7), two transverse sections (8) which are configured to be symmetrically curved and have a second length, which is less than the first length, each longitudinal section (7) and each transverse section (8) comprising at least one coil conductor (17) having at least one high-temperature superconductor tape (14), and the coil conductors (17) being connected to one another directly or indirectly, in particular low-ohmically, at the corners (5) of the saddle coil (2) by pressing and/or soldering.

In some embodiments, the connection in the corners (5) is produced by pressing high-temperature conductor tapes with indium and/or by soldering the high-temperature superconductor tapes (14) in overlap regions (15), or at least one connecting element (18), in particular consisting of copper, to which the high-temperature superconductor tapes (14) of the coil conductors (17) are respectively connected, is provided.

In some embodiments, the coil conductors (17) comprise a plurality of, in particular from two to six, high-temperature superconductor tapes (14).

In some embodiments, the high-temperature superconductor tapes (14) of a respective coil conductor (17) are guided at least partially above one another and/or at least partially parallel next to one another.

In some embodiments, the coil conductors (17) of the transverse sections (8) and the coil conductors (17) of the longitudinal sections (7) are different in respect of the number of high-temperature superconductor tapes (14) and/or their geometrical arrangement and/or their extent.

In some embodiments, in the case of high-temperature superconductor tapes (14) guided while lying above one another in a coil conductor (17), the high-temperature superconductor tapes (14) are guided at a distance from one another in the connecting region of the corners (5), a high-temperature superconductor tape (14) of the transverse section (8) following on from the corner (5) in each case being directly connected to a high-temperature superconductor tape (14) of the longitudinal section (7), and the high-temperature superconductor tapes (14) being arranged engaging in one another in the connecting region by using the spacing.

In some embodiments, in at least one connecting region of a corner (5), one of the coil conductors (17) to be connected, in which high-temperature superconductor tapes (14) are guided above one another, comprises a stepped end (16) that exposes the high-temperature superconductor tapes (14) at a distance in the longitudinal direction, and the other of the coil conductors (17) to be connected comprises high-temperature superconductor tapes (14) extending next to one another with an offset corresponding to the spacing, a pair of high-temperature superconductor tapes (14) respectively being connected directly to one another.

In some embodiments, in a connecting region of at least one corner (5), high-temperature superconductor tapes (14), guided next to one another, of the one coil conductor (17) all overlap, and are respectively all connected to, the high-temperature superconductor tapes (14) guided next to one another, which are to be connected, of the other coil conductor (17).

In some embodiments, in the case of a saddle coil (2) comprising a plurality of coil turns (6) and coil turns (6) more extended in height because of the connection at the corners (5), the coil conductors (17) are guided away from one another at the corners (5) and/or the coil turns (6) are separated by an insulator layer.

In some embodiments, the coil conductors (17) additionally comprise at least one conductor layer (20) made of a normally conducting material, in particular copper, which is in electrical contact with each high-temperature superconductor tape (14) of the respective coil conductor (17), in particular at least with a side of the high-temperature superconductor tapes (14) that comprises the high-temperature superconductor layer (19).

In some embodiments, in the connecting region of at least one corner (5), there is at least one free space for at least one high-temperature superconductor tape (14) to be connected, because of at least a part of the conductor layer (20) being omitted at the end of at least one coil conductor (17).

In some embodiments, one of the coil conductors (17) connected at a corner (5), in particular the coil conductor (17) assigned to a longitudinal section (17), comprises a smaller number of high-temperature superconductor tapes (14) than the other coil conductor (17), in particular the coil conductor (17) assigned to a transverse section (8), the high-temperature superconductor tapes (14) being connected to the respective conductor layer (20) on a high-temperature superconductor layer side (19) in the one coil conductor (17), and on a substrate side in the other.

In some embodiments, the high-temperature superconductor tapes (14) of the one coil conductor (17) are arranged above one another and the high-temperature superconductor tapes (14) of the other coil conductor (17) are arranged at least partially next to one another.

In some embodiments, the flat side of the high-temperature superconductor tapes (14) extends perpendicularly to the radial direction (10) of the rotor (2) in the installed state.

As another example, some embodiments include an electrical machine comprising a rotor (1), comprising at least two poles, having at least one saddle coil (2) as described herein.

### BRIEF DESCRIPTION OF THE DRAWINGS

Further advantages and details of the teachings of the present disclosure may be found in the exemplary embodiments described below and with the aid of the drawing, in which:

FIG. 1 shows a cross section of a rotor of an electrical machine incorporating teachings of the present disclosure having saddle coils incorporating teachings of the present disclosure;

FIG. 2 shows the structure of a coil turn of a saddle coil incorporating teachings of the present disclosure;

FIG. 3 shows an outline diagram of the connection of transverse sections and longitudinal sections;

FIG. 4 shows a first specific configuration of a corner of a saddle coil incorporating teachings of the present disclosure in a plan view;

FIG. 5 shows a cross section along the line V-V in FIG. 4;

FIG. 6 shows a cross section along the line VI-VI in FIG. 4;

FIG. 7 shows a second specific configuration of a corner of a saddle coil incorporating teachings of the present disclosure in a plan view;

FIG. 8 shows a cross section along the line VIII-VIII in FIG. 7;

FIG. 9 shows a cross section along the line IX-IX in FIG. 7;

FIG. 10 shows a third specific configuration of a corner of a saddle coil incorporating teachings of the present disclosure;

FIG. 11 shows a cross section along the line XI-XI in FIG. 10;

FIG. 12 shows spread coil conductors incorporating teachings of the present disclosure for providing a free space for the contacting;

FIG. 13 shows a fourth specific configuration of a corner of a saddle coil incorporating teachings of the present disclosure;

FIG. 14 shows a cross section along the line XIV-XIV in FIG. 13,

FIG. 15 shows a fifth specific configuration of the corner of a saddle coil incorporating teachings of the present disclosure;

FIG. 16 shows a cross section along the line XVI-XVI in FIG. 15;

FIG. 17 shows a cross section along the line XVII-XVII in FIG. 15;

FIG. 18 shows a sixth specific configuration of the corner of a saddle coil incorporating teachings of the present disclosure;

FIG. 19 shows a cross section along the line XIX-XIX in FIG. 18;

FIG. 20 shows a cross section along the line XX-XX in FIG. 18;

FIG. 21 shows a cross section along the line XXI-XXI in the connecting region in the case of a connection according to FIG. 15 or FIG. 18,

FIG. 22 shows a seventh specific configuration of the corner of a saddle coil incorporating teachings of the present disclosure;

FIG. 23 shows a cross section along the line XXIII-XXIII in FIG. 22; and

FIG. 24 shows a cross section along the line XXIV-XXIV in FIG. 22.

### DETAILED DESCRIPTION

Various embodiments of the teachings herein include a saddle coil for a rotor, comprising at least two poles, of an electrical machine accordingly has a rectangular shape and, for each coil turn, two straight longitudinal sections having a first length and, following on at a right angle from the longitudinal sections, two transverse sections which are configured to be symmetrically curved and have a second length, which is less than the first length, each longitudinal section and each transverse section comprising at least one coil conductor having at least one high-temperature superconductor tape, and the coil conductors being connected to one another directly or indirectly, in particular low-ohmically, at the corners of the saddle coil by pressing and/or soldering.

In some embodiments, saddle coils are essentially configured rectangularly in plan view and, for each coil winding, consist of four assembled sections, namely two longitudinal sections and two transverse sections. While a profile of the coil conductors, and therefore of the high-temperature superconductor tapes, corresponding to a straight line in the longitudinal sections, bending of the coil conductor into a saddle shape, in particular the shape of a segment of a circle, for the transverse sections. The high-temperature superconductor tapes of the short sides, i.e. of the transverse sections, may be connected directly, or alternatively indirectly, at a 90° angle to the high-temperature superconductor tapes of the longitudinal sections. Since these connections are required at each corner of the rectangular saddle coil, each coil turn comprises four such connections.

In some embodiments, high-temperature superconductor tapes, in particular ones made of second-generation high-temperature superconductors, can be connected with an extremely low resistance, i.e. low-ohmically, in particular at temperatures of around 30 kelvin. In this case, the total resistance of all the connections is still low enough to allow efficient cooling at these low temperatures, i.e. the operating temperatures of the saddle coil.

In some embodiments, the connections in the corners are produced by pressing high-temperature superconductor tapes with indium and/or by soldering the high-temperature superconductor tapes in overlap regions, as is described for example in the articles mentioned in the introduction by S. Ito et al. and S. L. Lalitha/T. Lérevisse et al., respectively. These pressing or soldering connection techniques already provide extremely low resistances in the connecting region at the corners, reducing the total resistance of the connections.

In some embodiments, the flat side of the high-temperature superconductor tapes is oriented in such a way that, in the installed state, it extends at least substantially perpendicularly to a radial direction of the rotor, and does so at each position of the saddle coil. The high-temperature superconductor tapes of the transverse sections are in this case bent with a suitable radius in order to form a segment of a circle; because of the perpendicular orientation of the flat side with respect to the radial direction of the rotor, the curvature is formed by bending the high-temperature superconductor tapes in the “easily bendable” direction of the high-temperature superconductor tapes, and therefore in such a way that the least possible disadvantageous consequences occur owing to the mechanical load.

As a result, the region of the rotor axis is kept free. In each case, the flat sides of the high-temperature superconductor tapes at the corners lie at least substantially, in the case of direct connection entirely, in the same plane, so that a maximal overlap is provided, which contributes to further reducing the contact resistances. In some embodiments, the high-temperature superconductors used for the high-temperature superconductor tapes are second-generation high-temperature superconductors, for which many low-resistance contact possibilities are known.

For power plant generators (utility generators) as electrical machines, the first length may be from 4 to 8 meters and the second length from 0.5 to 1 meter.

In some embodiments, at least one connecting element, in particular consisting of copper, to which the high-temperature superconductor tapes of the coil conductors are respectively connected, may be provided. In this case, there is thus an indirect connection of the high-temperature superconductor tapes, which is produced by a connecting element, in particular consisting of copper. Such a connecting element may have the advantage that a larger contact area is available during the soldering/pressing, which may likewise lead to extremely low resistance values. Furthermore, a connecting element acts as a kind of “distribution point”, via which the current flowing through the respective coil conductors may be redistributed suitably, for example in the event of a defective high-temperature superconductor tape in one of the coil conductors. The connecting element may have profiling, or shaping, which is matched to the corresponding ends of the coil conductors, in particular the positions of the high-temperature superconductor tapes in the coil conductors, in order as far as possible to provide maximally optimal contact possibilities for each high-temperature superconductor tape.

In some embodiments, a high-temperature superconductor tape usually comprises a high-temperature superconductor layer applied onto a metallic substrate, in which case at least one buffer layer may also be provided between the substrate, i.e. the substrate layer, and the high-temperature superconductor layer. In this regard, the high-temperature superconductor tape comprises a high-temperature superconductor layer side and a substrate side. In some embodiments, the connections, particularly in the case of direct connection of high-temperature superconductor tapes, may be on the high-temperature superconductor layer side.

In some embodiments, the coil conductors and the connecting regions are configured to be electrically insulated, to which end known procedures may in principle be used. For example, the coil conductors and/or the connecting regions may be impregnated with a resin after application of an insulation material, for example glass-fiber fabric.

General advantages of a saddle coil incorporating teachings of the present disclosure and analogous electrical machines are firstly that no complex 3D winding technique for a plurality of high-temperature superconductor tapes, which are provided in parallel, or even only a single high-temperature superconductor tape, needs to be developed. In some embodiments, all the high-temperature superconductor tapes in the rotor can be oriented perpendicularly to the radial direction, so that the strong centrifugal force in the rotor acts as a pressure only in a direction perpendicular to the plane of the high-temperature superconductor tapes, and therefore not as a shear load or shear stress. It has been found that high-temperature superconductor tapes can withstand pressure perpendicular to their flat side particularly well.

In some embodiments, the coil turns may be composed of short high-temperature superconductor tape pieces, in the aforementioned example up to a few meters long. High-temperature superconductor tapes of the highest quality may therefore be ordered and used by the manufacturer, even if this quality cannot yet be produced reliably and uniformly over high-temperature superconductor tapes with a length of hundreds of meters used for winding.

In summary, an additional configuration option for rotors in electrical machines, in particular large two-pole machines such as power plant generators, includes the saddle coils described herein. A high-temperature superconductor, in particular a second-generation high-temperature superconductor, for which the rotor, or at least the rotor coil, needs to be kept at low operating temperatures, is used. The saddle coils described herein allow the coolant to be fed along the rotor axis, since no coil conductors need to be guided along there, even though in the longitudinal sections, the coil conductors, according to the ideal case, are guided in the midplane (equatorial plane) of the rotor. Furthermore, an excessive space requirement at winding heads is not necessary.

In some embodiments, there are a plurality of saddle coils in a rotor, or saddle coils with a different number of turns in a different arrangement in the manner described herein. Overall, machines with high-temperature superconductors in the rotor thus become more attractive than conventional electrical machines equipped with copper conductors. The coil conductors may comprise a plurality of, in particular from two to six, high-temperature superconductor tapes. In this case, the number of high-temperature superconductor tapes may be even, since in this way, as will be explained in more detail below, the best configurations can be achieved in respect of the connecting regions at the corners. For the number of tapes required, the width is of course also to be taken into account. Since high-temperature superconductor tapes exist in different widths, in case of doubt about a width adaptation, an even number of the high-temperature superconductor tapes required in a coil conductor may also be achieved. In general, it has been found in practice that from two to six high-temperature superconductor tapes are usually sufficient in order to carry the required current in a power plant generator as an electrical machine.

In some embodiments, the high-temperature superconductor tapes of a respective coil conductor may be guided at least partially above one another (face-to-face) and/or at least partially parallel next to one another (edge-to-edge). It is thus as one alternative possible to guide the high-temperature superconductor tapes in such a way that their flat sides face one another, i.e. they form a stack, which allows an extremely compact configuration of the coil conductor. If the required space is available, it is however conceivable to guide the high-temperature superconductor tapes next to one another (with their narrow sides facing one another), which, as will be discussed in more detail below, may offer advantages in respect of the contacting in the connecting regions.

In some embodiments, less installation space is usually available in relation to the longitudinal sections of the saddle coil in the rotor, so that a compact configuration may be useful, i.e. high-temperature superconductor tapes are guided above one another. In the end regions of the rotor, in which the transverse sections are placed, more installation space is however often available, so that configurations in which the high-temperature superconductor tapes lie next to one another (and a wide coil conductor is therefore formed) may be used here. Combinations of high-temperature superconductor tapes arranged above one another in the longitudinal sections and superconductor tapes arranged next to one another in the transverse sections may lead to extremely low-resistance, easily connectable combinations, which possibly have further advantages, as will be explained in more detail below.

In some embodiments, the coil conductors of the transverse sections and the coil conductors of the longitudinal sections may differ in respect of the number of high-temperature superconductor tapes and/or their geometrical arrangement and/or their extent. In contrast to wound rotor coils, there are many additional degrees of freedom, particularly in respect of locally adapting the longitudinal sections and the transverse sections, for example to the requirements of the installation space and/or the field conditions, in which case a different configuration may also be used to produce an improved resistance in the connecting regions at the corners. In some embodiments, the transverse sections have a larger number of high-temperature superconductor tapes, for example in order to compensate for a reduction in size and/or unfavorable contacting of an additional compensating conductor layer, and the like.

In some embodiments, in the case of high-temperature superconductor tapes guided while lying above one another in a coil conductor, the high-temperature superconductor tapes may be guided at a distance from one another in the connecting region of the corners, a high-temperature superconductor tape of the transverse section following on from the corner in each case being directly connected to a high-temperature superconductor tape of the longitudinal section, and the high-temperature superconductor tapes being arranged engaging in one another in the connecting region by using the spacing. A corresponding configuration could also be produced in the case of a connecting element that then has an engagement profile into which the spaced-apart high-temperature superconductor tapes engage for the respective contacting. The spacing of the high-temperature conductor tapes may be achieved by spreading out at the ends, although a suitable spacing may be achieved in any case, for example by other layers, for example by additional normally conducting conductor layers, in particular made of copper, provided for balancing or compensation in the event of heavy currents.

In some embodiments, in at least one connecting region of a corner, one of the coil conductors to be connected, in which high-temperature superconductor tapes are guided above one another, comprises a stepped end that exposes the high-temperature superconductor tapes at a distance in the longitudinal direction, and the other of the coil conductors to be connected comprises high-temperature superconductor tapes extending next to one another with an offset corresponding to the spacing, a pair of high-temperature superconductor tapes respectively being connected directly to one another. Also for a stepped configuration, with the presence of a connecting element, which then has a corresponding matching, stepped connecting profile. In the event that a direct connection of the high-temperature superconductor tapes is provided, it is in this context expedient for the high-temperature superconductor tapes, extending next to one another, of the other superconductor, in particular of the transverse section, to be offset in their height according to the stepping of the stepped end. In this way, particularly simple contacting may be achieved, and in the case of direct contacting of the high-temperature superconductor tapes, the high-temperature superconductor layer sides may be connected to one another, as is generally expedient.

In some embodiments, in a connecting region of at least one corner, high-temperature superconductor tapes, guided next to one another, of the one coil conductor all overlap, and are respectively all connected to, the high-temperature superconductor tapes guided next to one another, which are to be connected, of the other coil conductor. In this way, a maximal contact area is provided between the high-temperature superconductors of the coil conductors to be connected, which on the one hand significantly lowers the resistance and, on the other hand, allows redistribution of currents between individual high-temperature superconductor tapes in a particularly simple way. In this case as well, a combination with a stepped end may moreover readily be envisioned. In the case of high-temperature superconductor tapes guided correspondingly next to one another, a large contact area is moreover also obtained when using a connecting element, so that corresponding configurations may also be expedient when providing such a connecting element.

With respect to the interconnected connecting element, which may for example be formed as a solid end piece and/or from highly conductive material, in particular copper or aluminum, it should generally also be noted that although such a connecting element may add some weight and resistance, on the other hand it allows a significantly larger connecting area per high-temperature superconductor tape, so that the total resistance can be lowered. Such a configuration may, for example, be expedient when the internal interfacial resistances in the high-temperature superconductor tapes are too high and/or are not distributed uniformly and/or cannot be predicted sufficiently well. When using such connecting elements, it is furthermore the case that they are easier to insulate, can be mechanically fastened and can be connected to a cooling device of the electrical machine for the rotor.

The four basic possibilities mentioned above (guiding the high-temperature superconductor tapes as a stack/next to one another; stepped end; connecting element; one high-temperature superconductor tape/a plurality of high-temperature superconductor tapes) may be optimally combined according to the situation for the corresponding saddle coils/rotors and the specific applications, so that, for example, sixteen different configurations are already provided here by different combinations.

In the case of a saddle coil comprising a plurality of coil turns and coil turns more extended in height because of the connection at the corners, the coil conductors may be guided away from one another at the corners and/or the coil turns may be separated by an insulator layer. Finally, the coil conductors may be spread out in order to provide the space for the connections, and/or spacings may be provided anyway between the individual coil conductors, for example by insulating material.

In some embodiments, additional conductor material is used for electrical compensation, the arrangement or specific configuration of which may likewise be used in order to provide spaces which are used for the specific contacting of the high-temperature superconductor tapes of the coil conductors. In some embodiments, the coil conductors may therefore additionally comprise at least one conductor layer made of a normally conducting material, in particular copper, which is in electrical contact with each high-temperature superconductor tape of the respective coil conductor, in particular at least with a side of high-temperature superconductor tapes that comprises the high-temperature superconductor layer. Such a conductor layer may, for example in the event of a current surge, receive a part of the current carried by the coil conductor. The conductor layer is therefore used for electrical stabilization and provides a parallel resistance; particular advantages are, especially when using copper as a normally conducting conductor material, an outstanding thermal conduction and/or heat capacity as well.

In some embodiments, in the connecting region of at least one corner, there may now be at least one free space for at least one high-temperature superconductor tape to be connected, because of at least a part of the conductor layer being omitted at the end of at least one coil conductor. The presence of the additional conductor material therefore offers the flexibility of providing free spaces for the actual contacting of the high-temperature superconductor tapes, by the conductor layer already ending shortly before reaching the corner and therefore providing the corresponding free space. In this way, spreading and/or coil conductors on insulation material which are assigned in respect of different coil turns, and the like, may be obviated at least partially, preferably fully.

In some embodiments, one of the coil conductors connected at a corner, in particular the coil conductor assigned to a longitudinal section, may comprise a smaller number of high-temperature superconductor tapes than the other coil conductor, in particular the coil conductor assigned to a transverse section, the high-temperature superconductor tapes being connected to the respective conductor layer on a high-temperature superconductor layer side in the one coil conductor, and to the substrate side in the other. In this way, it is possible to produce a longitudinal section satisfying even smaller installation spaces, by the high-temperature superconductor tapes, which are fewer in their number, being connected, while being guided over one another, on their high-temperature superconductor layer side to the at least one conductor layer. If this is not the case for the transverse section, i.e. the conductor layer follows on there on the substrate side, this may be compensated for by means of additional high-temperature superconductor tapes. Specifically, the high-temperature superconductor tapes of the one coil conductor, in particular of the longitudinal section, may therefore be arranged above one another and the high-temperature superconductor tapes of the other coil conductor may be arranged at least partially next to one another.

In some embodiments, a synchronous machine comprises a rotor, comprising at least two poles, having at least one saddle coil described herein. All comments relating to the saddle coil may also be applied similarly to the electrical machines of the present disclosure, with which the aforementioned advantages may thus likewise be obtained. In some embodiments, the rotor is a two-pole rotor, while the electrical machine is preferably a power plant generator (utility generator). In some embodiments, the flat side of the high-temperature superconductor tapes extends at least substantially, in particular entirely, perpendicularly to the radial direction of the rotor.

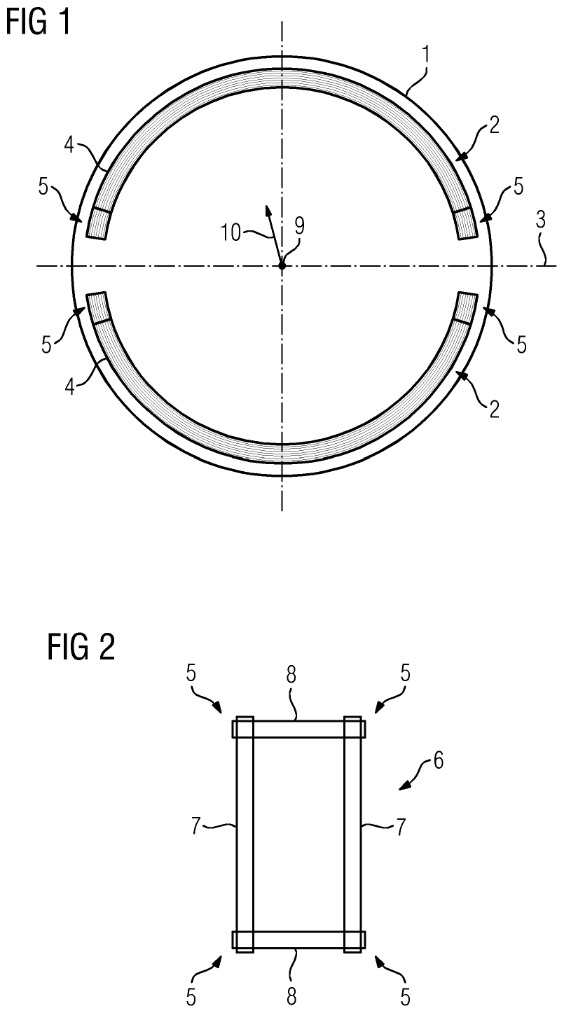

FIG. 1 shows, as an outline diagram, a two-pole rotor 1 of an electrical machine with a rotor 1 rotatably mounted inside a stator (not represented here for the sake of clarity) of the electrical machine. The rotor 1 comprises two saddle coils 2, which are arranged symmetrically with respect to a midplane 3 (equatorial plane) of the rotor 1. The electrical machine may, in particular, be a power plant generator. Of the saddle coil 2, in the present case mainly the head-side head pieces 4 may be seen, which at corners 5 are connected turn-wise to longitudinal pieces consisting of corresponding longitudinal sections.

FIG. 2 shows the structure of a coil turn 6 of the saddle coil 2 in this regard in more detail in a plan view. It may be seen that the coil turns 6, and therefore the saddle coil 2, are configured rectangularly in the plan view and respectively comprise longitudinal sections 7, which extend in the axial direction of the rotor 1, and transverse sections 8, which form the head pieces 4. The sections 7, 8 are respectively connected at the corners 5, as will be explained in more detail below. The transverse sections 8 are curved in the shape of a segment of a circle, as may be seen from FIG. 1, so that the saddle shape of the saddle coil 2 is formed. In this way, the region around the rotor axis 9 can be kept free for the attachment of a cooling device (not shown in detail here) of the electrical machine and electrical lines.

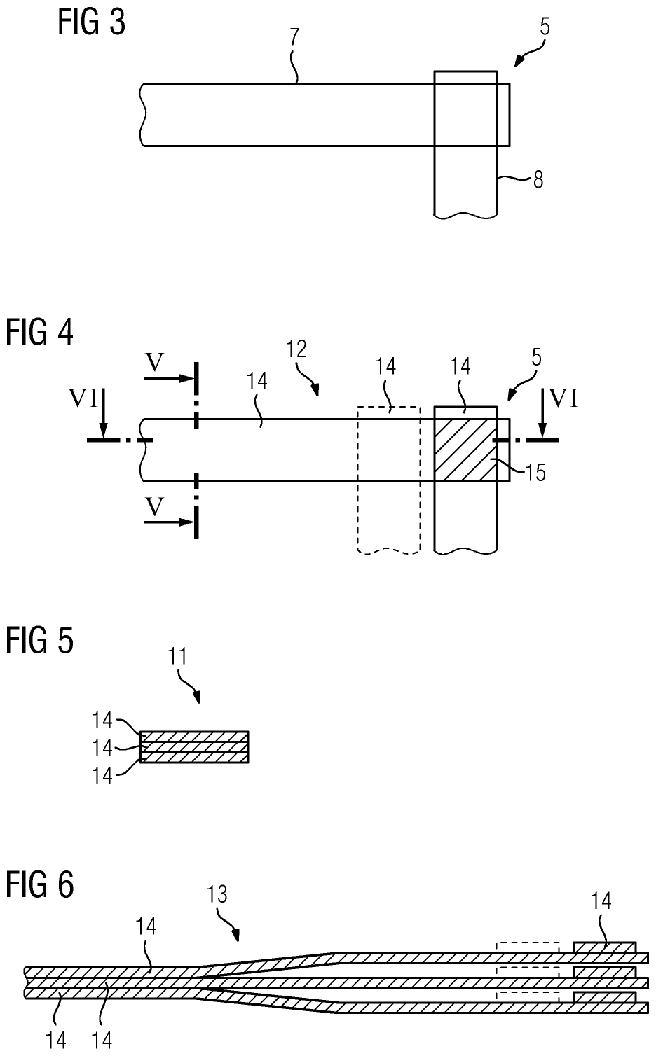

The longitudinal sections 7 and the transverse sections 8 respectively comprise at least one high-temperature superconductor tape in the coil conductor formed by them, a plurality of high-temperature superconductor tapes, in particular from 2 to 6, usually being provided. The flat sides of the high-temperature superconductor tapes in this case extend inside the rotor 1 in such a way that they always extend perpendicular to the respective radial direction 10 of the rotor 1, so that the curvature of the transverse sections 8/the head pieces 4 is also selected accordingly. The effect of this is that not only the bending of the transverse sections 8 takes place in the “easy” direction, the least mechanically loaded bending direction of the high-temperature superconductor tapes, but also that the high centrifugal force in the rotor 1 acts as a pressure only in a direction perpendicular to the plane of the high-temperature superconductor tapes, where they withstand these forces particularly well. In the corners 5, in corresponding connecting regions, the superconductors of the longitudinal sections 7 and of the transverse sections 8 are connected at an angle of 90°, as is shown more clearly in FIG. 3.

The high-temperature superconductor tapes respectively comprise on one side a high-temperature superconductor layer made of a high-temperature superconductor, in particular a second-generation high-temperature superconductor, which is carried by a substrate. Buffer layers may be provided between the substrate and the high-temperature superconductor layer.

The direct connection of high-temperature superconductor tapes at the corners 5 is produced by pressing with indium or soldering on the high-temperature superconductor layer sides. Corresponding methods are known from the articles already discussed in the general description, so that there is a low-ohmic connection, which remains able to be cooled well.

The following figures now represent specific embodiments of the connecting regions at the corners 5 in greater detail, only the high-temperature superconductor tapes and their profile initially being shown in detail for the sake of clarity in the exemplary embodiment of FIGS. 4 to 8; refinements are represented in FIGS. 9 to 12 when there is an additional conductor layer made of a normally conducting material, in particular copper. In this case, it is the convention that the coil conductor of the longitudinal section 7 extends horizontally in these figures, and the coil conductor of the transverse section 8 extends vertically.

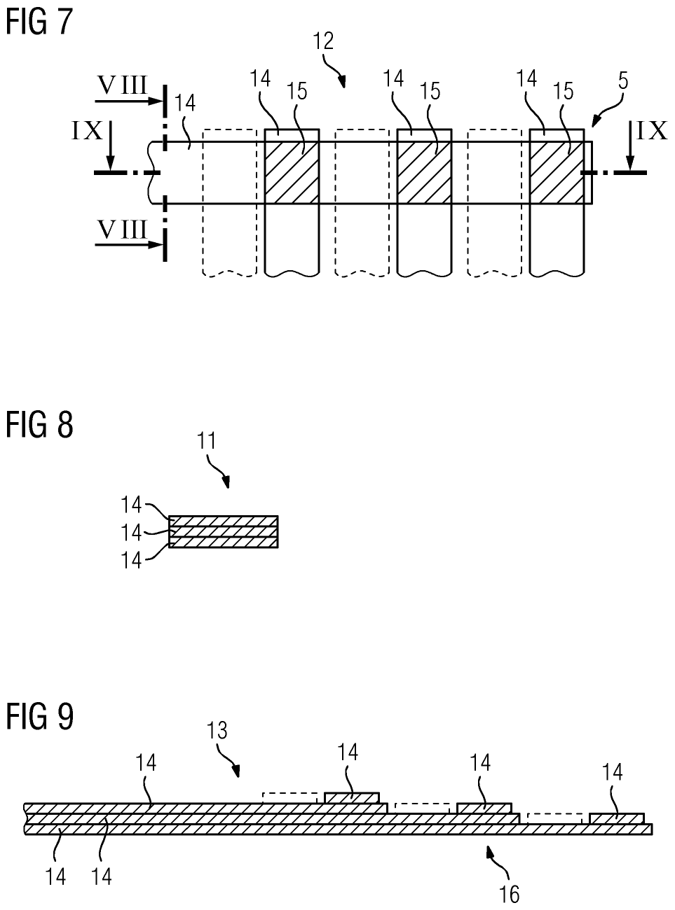

FIGS. 4 to 6 show a plan view 12 of the connecting region in FIG. 4, a cross section 11 of the respective coil conductor in relation to the high-temperature superconductor tapes 14 in FIG. 5, and a cross section of the connecting region in FIG. 6. In this case, as in FIGS. 7 to 14, three high-temperature superconductor tapes of the coil conductor of the longitudinal section 7 are represented here by way of example; the coil conductor of the transverse section 8 may, for each high-temperature superconductor tape 14 of the coil conductor of the longitudinal section 7, comprise a plurality of, for example 2, high-temperature superconductor tapes 14; these optional additional high-temperature superconductor tapes are indicated by dashes in FIGS. 4 to 14.

As shown by FIGS. 5 and 6 in the cross sections 11 and 13, the high-temperature superconductor tapes 14 of both coil conductors are arranged above one another there, that is to say in an extremely space-spacing arrangement, i.e. as a stack. At the ends of the coil conductors which are placed toward the corner 5, as shown by the cross section 13, they are spread out such that the high-temperature superconductor tapes 14 can engage in one another and can be connected in the corresponding overlap regions 15 directly to a high-temperature superconductor tape 14 of the respective other coil conductor. However, more space in the height direction is required because of the spreading in the connecting region.

It should be mentioned that, in principle, it is also conceivable to connect each coil conductor to the respective other coil conductor only at one position, although this is less preferred.

FIGS. 7 to 9 show a second exemplary embodiment, in which the height required in the region of the corner 5 is reduced. As shown by the cross section in FIG. 9, the coil conductor 13, which again enters with high-temperature superconductor tapes 14 stacked above one another of the longitudinal section 7, is configured to be stepped at its end 16, so that in particular successive sections some of the high-temperature superconductor tapes 14 stacked above one another are exposed. In the coil conductor of the transverse section 8, the high-temperature superconductor tapes are now arranged laterally next to one another, offset by the stepped distance and ideally also offset slightly in terms of their height, so that they come directly in contact with the associated high-temperature superconductor tape 14 of the coil conductor of the longitudinal section and can correspondingly be connected thereto, for example by pressing or soldering. In this case, less space is required in the height direction and therefore less space at the coil heads, although the coil conductor of the transverse section 8 is configured to be wider. The embodiment shown in FIGS. 4 to 6 is to be regarded overall as being somewhat more robust.

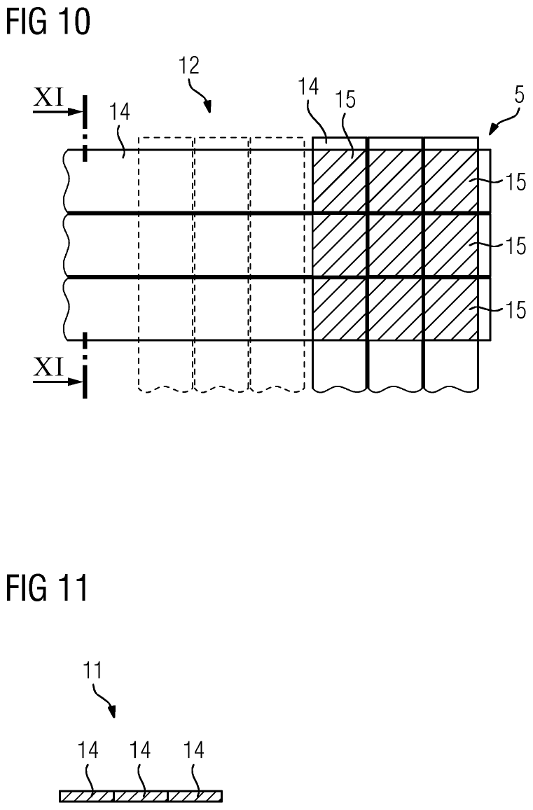

FIGS. 10 and 11 show a further exemplary embodiment, in which both the high-temperature superconductor tapes 14 of the coil conductor of the longitudinal section 7 and the high-temperature superconductor tapes 14 of the coil conductor of the transverse section 8 are arranged next to one another, and in the connecting region of the corner 5 respectively overlap with each high-temperature superconductor tape 14 of the respective other coil conductor, so that the contact region for the connection is significantly increased, simple redistribution of current loads can take place and there is a large attachment region for cooling connections. The large contact region, cf. overlap regions 15, ensures a low total resistance.

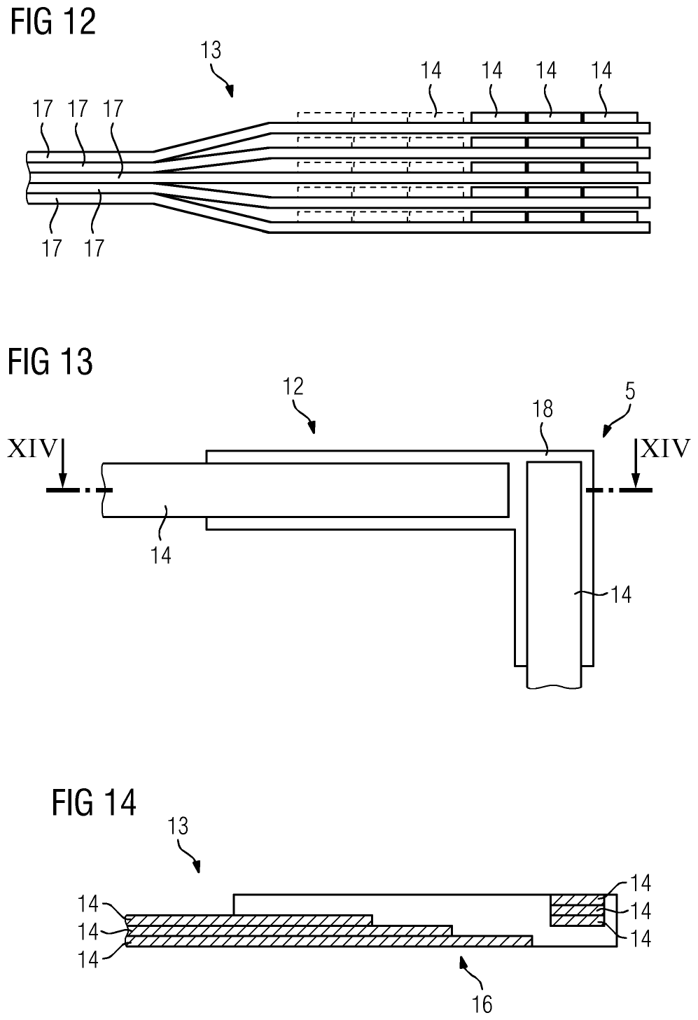

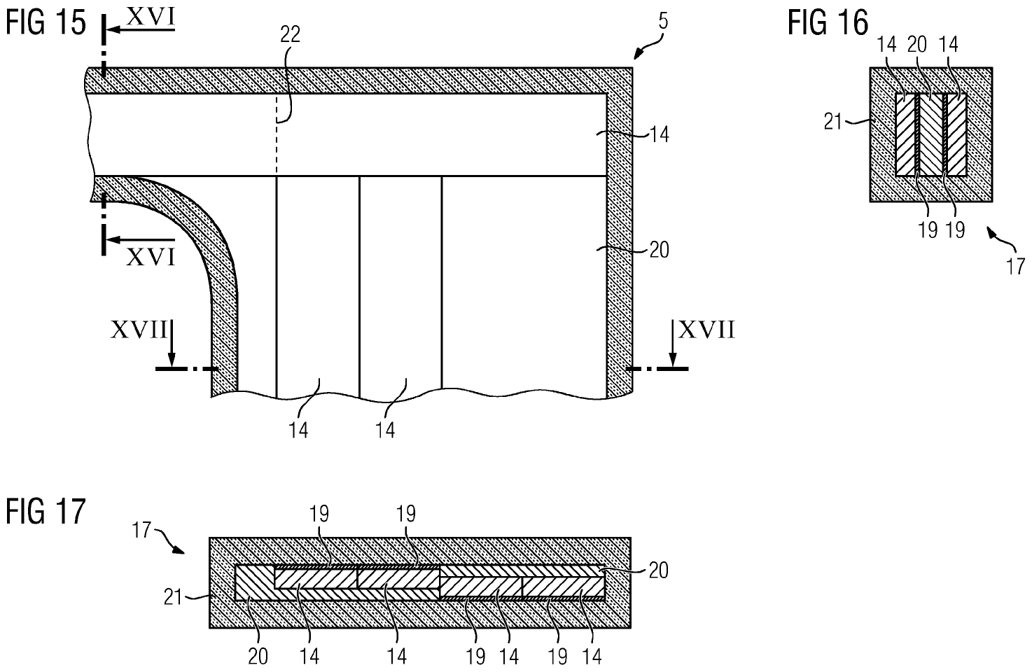

FIG. 12 shows spreading of a plurality of coil conductors 17 placed above one another, which may belong to different coil turns or the same coil turn, for the embodiment shown in FIGS. 10 to 12. For each of the coil conductors 17 sufficient space is obtained in order to produce the connection to the correspondingly spread coil conductors 17 of the transverse section 8, the (optional and in this exemplary embodiment in any case present) high-temperature superconductor tapes 14 of which are correspondingly shown. The coil conductors 17 may, particularly in the case of different coil turns, also be spaced apart by insulation material in order at least partially to avoid spreading. Further possibilities, particularly also in the case of a single coil turn, are provided by the examples represented in relation to FIGS. 15 to 24 with an additional conductor layer.

FIGS. 13 and 14 show a fourth exemplary embodiment of the connection in the corner 5, a connecting element 18, made of copper, being used, which is profiled in order to receive the (in turn configured to be stepped) ends 16 of the two coil conductors 17, in which three high-temperature superconductor tapes 14 lie above one another, and in order to provide a contact area for the high-temperature superconductor layer side of each high-temperature superconductor tape 14. The connecting element 18 adds weight and resistance, but allows a larger contact region per high-temperature superconductor tape 14, so that the total resistance decreases. Furthermore, the mechanical robustness is increased and the attachment to a cooling system is simplified.

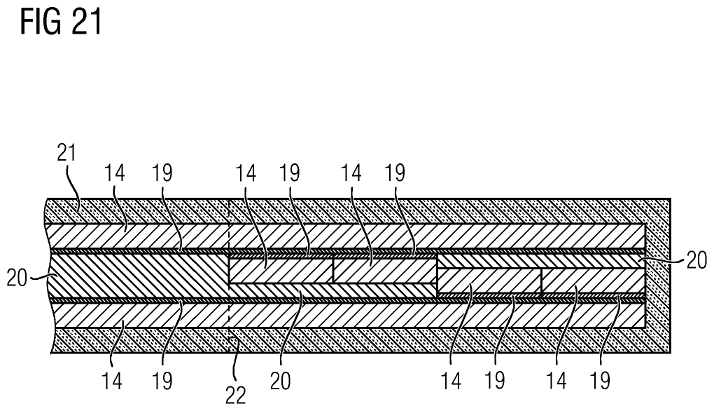

FIGS. 15 to 24 now show configurations in which at least one conductor layer made of a normally conducting material, here copper, is additionally used. This allows additional flexibility, particularly as regards the provision of free spaces in the connecting region at the corners 5. In this case, FIGS. 15, 18 and 22 respectively show a (partially cutaway) plan view of the corner 5; cross sections of the coil conductors are shown by FIGS. 16, 17, 19, 20, 23 and 24, and a connecting region cross section is shown by FIG. 21.

The fifth exemplary embodiment of FIGS. 15 to 17 in this case uses a coil conductor 17 of the longitudinal section 8, which comprises two high-temperature superconductor tapes 14 that are guided above one another with high-temperature superconductor layers 19 facing one another, the conductor layer 20 made of copper being arranged between the high-temperature superconductor tapes 14. An insulating material 21 is indicated around them. For the coil conductor 17 of the transverse section 8, which runs in from below in FIG. 15, it may be seen that high-temperature superconductor tapes 14 arranged next to one another here are provided in pairs respectively with a slight height offset. The high-temperature superconductor layers 19 in this case face outward, away from the conductor layers 20 also provided there, so that there is a poorer contact, although there are more high-temperature superconductor tapes than in the coil conductor 17 of the longitudinal section 7.

The conductor layer 20 of the coil conductor 17 of the longitudinal section 7 ends at a position 22 in order to provide a free space, into which the high-temperature superconductor tapes 14 of the coil conductor 17 of the transverse section 8 can project, the high-temperature superconductor layers 19 respectively being adjacent to one another and being directly connected by one of the methods mentioned. In this case, in this exemplary embodiment, use is moreover made of the fact that there is more space at the rotor head, and the coil conductor 17 of the transverse section 8 can therefore be configured to be more extended than the coil conductor 17 of the longitudinal section 7.

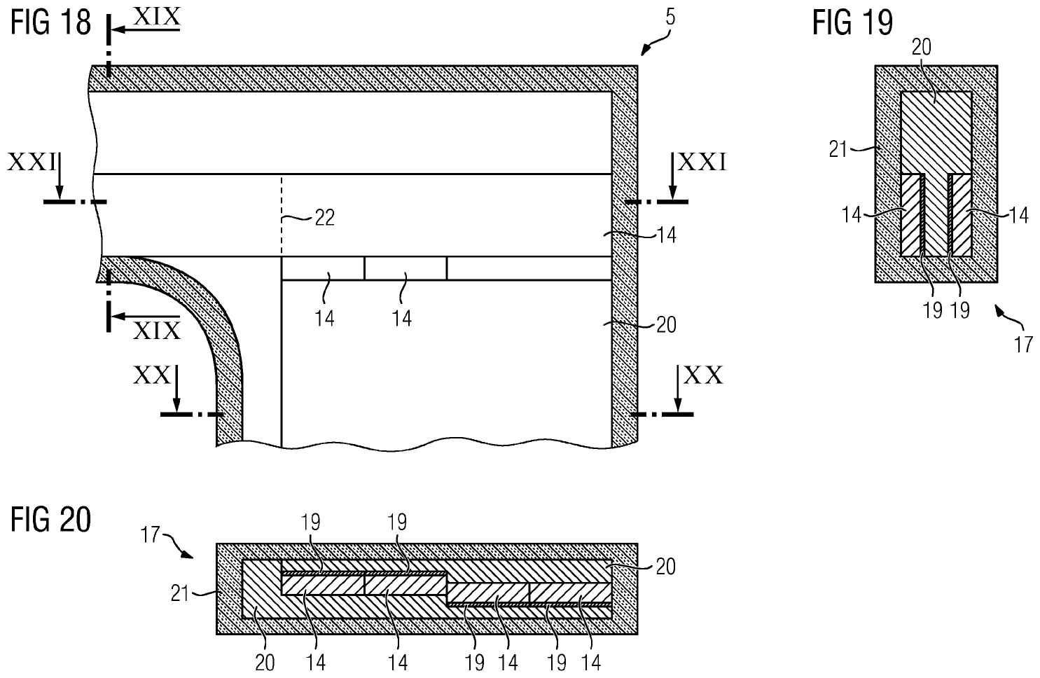

While the exemplary embodiment of FIG. 15 is configured for a minor addition of copper, FIGS. 18 to 20 show a modification for a case in which a larger amount of copper is intended to be used for each of the coil conductors 17. As may be seen, the copper material of the conductor layer 20 now also extends further next to the high-temperature superconductor tapes 14, while the conductor layers 20 of the coil conductor 17 of the transverse section 8 are widened in such a way that the copper also contacts the high-temperature superconductor tapes 14 on the side of the high-temperature superconductor layer 19. The covering parts of the conductor layers 20 also end here correspondingly before the connecting region in the corner 5, in order to allow the corresponding connection.

FIG. 21 shows a cross section along the line XXI-XXI in FIG. 18, which also explains the connecting region in more detail for FIGS. 15 to 17. Clearly shown is the ending of the conductor layer 20 of the coil conductor 17 of the longitudinal section 7 between the high-temperature superconductor tapes 14 of this coil conductor, in order to provide a free space into which the high-temperature superconductor tapes 14 of the other coil conductor 17 of the transverse section 8 engage, so that the high-temperature superconductor tapes 14 are respectively connected with their sides of the high-temperature superconductor layer 19. In this case, ideally, no thickening in the connecting region is required.

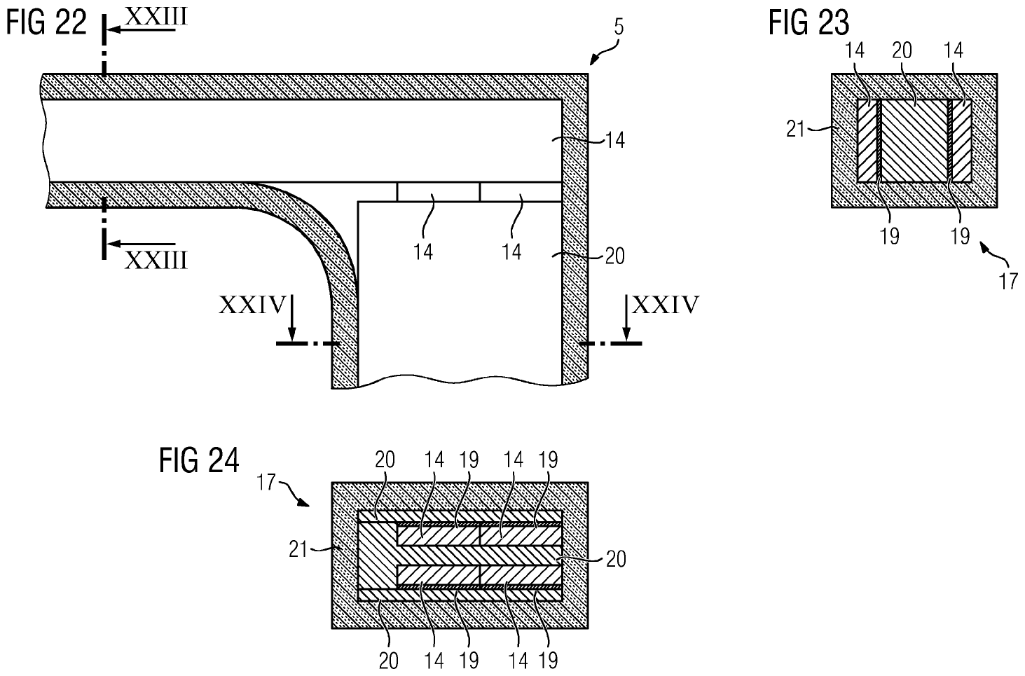

FIGS. 22 to 24 lastly show a further embodiment, in which a large amount of copper is likewise required. While the coil conductor 17 of the longitudinal section 7 is again configured as in FIGS. 15 to 17, but with a thicker conductor layer 20, the additional space used by the thicker conductor layer 20 of the coil conductor 17 of the longitudinal section 17 is used for the coil conductor 17 of the transverse section 8, so that respectively two high-temperature superconductor tapes 14 guided next to one another are arranged above one another, a conductor layer 20 additionally being provided between them.

This again illustrates the many options that are obtained because of the flexibility of the possibility of the different configuration of the coil conductors 17 of the longitudinal section 7 and of the transverse section 8, and by the addition of copper.

Although the teachings herein have been illustrated and described in detail with the aid of exemplary embodiments, the scope of the disclosure is not restricted by the examples disclosed, and other variants may be derived therefrom by the person skilled in the art without departing from the protective scope thereof.

What is claimed is:

1. A saddle coil for a rotor, the saddle coil comprising:
two poles of an electrical machine having a plurality of coil turns;
for each coil turn of the plurality of coil turns, two straight longitudinal sections having a first length and, following on at a right angle from the longitudinal sections, two transverse sections symmetrically curved and with a second length less than the first length;
wherein each longitudinal section and each transverse section includes a coil conductor with a high-temperature superconductor tape;
the coil conductors are connected to one another at the corners of the saddle coil by pressing and/or soldering.

2. The saddle coil as claimed in claim 1, wherein the connection in the corners is produced by pressing high-temperature conductor tapes with indium and/or by soldering the high-temperature superconductor tapes in overlap regions, or at least one connecting element comprising copper, to which the high-temperature superconductor tapes of the coil conductors are respectively connected.

3. The saddle coil as claimed in claim 1, wherein the coil conductors each comprise a plurality of high-temperature superconductor tapes.

4. The saddle coil as claimed in claim 3, wherein the high-temperature superconductor tapes of a respective coil conductor are guided at least partially above one another and/or at least partially parallel next to one another.

5. The saddle coil as claimed in claim 3, wherein the coil conductors of the transverse sections and the coil conductors of the longitudinal sections are different in respect of the number of high-temperature superconductor tapes and/or their geometrical arrangement and/or their extent.

6. The saddle coil as claimed in claim 3, wherein:
the high-temperature superconductor tapes lie above one another in a coil conductor;
the high-temperature superconductor tapes are guided at a distance from one another in the connecting region of the corners;
a high-temperature superconductor tape of the transverse section following on from the corner is in each case directly connected to a high-temperature superconductor tape of the longitudinal section; and
the high-temperature superconductor tapes engage in one another in the connecting region by using the spacing.

7. The saddle coil as claimed in claim 3, wherein:
high-temperature superconductor tapes are guided above one another;
in at least one connecting region of a corner, one of the coil conductors comprises a stepped end exposing the high-temperature superconductor tapes at a distance in the longitudinal direction;
the other of the coil conductors to be connected comprises high-temperature superconductor tapes extending next to one another with an offset corresponding to the spacing; and
a pair of high-temperature superconductor tapes are respectively connected directly to one another.

8. The saddle coil as claimed in claim 3, wherein:
in a connecting region of at least one corner, high-temperature superconductor tapes, guided next to one another, of the one coil conductor all overlap; and
the high-temperature superconductor tapes are respectively all connected to the high-temperature superconductor tapes guided next to one another, which are to be connected, of the other coil conductor.

9. The saddle coil as claimed in claim 1, wherein:
the plurality of coil turns are extended in height because of the connection at the corners; and
the coil conductors are guided away from one another at the corners and/or the coil turns are separated by an insulator layer.

10. The saddle coil as claimed in claim 1, wherein the coil conductors comprise conductor layer of a normally conducting material in electrical contact with each high-temperature superconductor tape of the respective coil conductor.

11. The saddle coil as claimed in claim 10, wherein:
in the connecting region of at least one corner, there is a free space for at least one high-temperature superconductor tape to be connected, because of at least a part of the conductor layer being omitted at the end of at least one coil conductor.

12. The saddle coil as claimed in claim 10, wherein:
a particular one of the coil conductors connected at a corner comprises a smaller number of high-temperature superconductor tapes than the other coil conductor;
the high-temperature superconductor tapes are connected to the respective conductor layer on a high-temperature superconductor layer side in the one coil conductor, and on a substrate side in the other.

13. The saddle coil as claimed in claim 12, wherein the high-temperature superconductor tapes of the one coil conductor are arranged above one another and the high-temperature superconductor tapes of the other coil conductor are arranged at least partially next to one another.

14. The saddle coil as claimed in claim 1, wherein a flat side of the high-temperature superconductor tapes extends perpendicularly to the radial direction of the rotor once installed.

15. (canceled)
